(19) United States
(12) Patent Application Publication
(10) Pub. No.: US 2010/0206339 A1
(43) Pub. Date: Aug. 19, 2010

(54) WASHING SYSTEM FOR RETURNABLE AND REUSABLE PACKAGES AND A METHOD OF FEEDING PACKAGES IN THE SYSTEM

(76) Inventor: Troels Jakobsen, Arhus C (DK)

Correspondence Address: WILLIAM J. SAPONE;COLEMAN SUDOL SAPONE P.C., 714 COLORADO AVENUE, BRIDGE PORT, CT, 06605, US

(21) Appl. No.: 12/664,071

(22) PCT Filed: May 15, 2008
(86) PCT No.: PCT/DK2008/000179

§ 371 Date: Apr. 29, 2010

(30) Foreign Application Priority Data
Jun. 15, 2007 (DK) PA 2007 00864

(51) Int. Cl. B08B 7/00; B08B 13/00

(52) U.S. Cl. 134/32; 134/72; 134/73; 134/74

(57) ABSTRACT

When, according to the invention, a washing system (1) is made of a pipe of synthetic material, where the pipe is divided into a washing tunnel (5) and a tank (6) separated by a package conveyor (3) and a drain bottom (7), a washing system is achieved, where the system may be advantageously by established by coupling a plurality of pipes together and by introducing a fully mounted drain bottom via an open pipe end. The selection of synthetic material as a pipe material results in great savings of material, while providing a tunnel which is stable and self supporting, and which is sound and heat insulating and hygienic, so that both the initial and the operating costs are reduced significantly.

### THE PRIOR ART

The invention relates to a washing system for returnable and reusable packages for foods and beverages or other products, in particular for the washing of boxes, trays, pallets and the like of plastics or steel, said washing system comprising a tunnel which is provided with equipment for softening, washing, flushing and drying, said equipment comprising nozzles, partition curtains, air blowers, tanks and filter and pump units, as well as a package conveyor which binds the sections together, and which is also adapted to cooperate with supply as well as discharge arrangements, and in which the tunnel further comprises a pipe of synthetic material which is generally cylindrical and disposed substantially horizontally.

Modern production and distribution systems are large-scale users of packages of many types, and boxes, trays and pallets of plastics and steel constitute a very great proportion of these. The value of these packages is considerable per se, and, therefore, they are reused to a great extent.

Reuse of these packages in the field of food processing and distribution requires that they are cleaned to such a degree as allow them to comply with the hygiene requirements which the authorities have laid down in the field concerned, or which the customers require.

The cleaning requirements have resulted in the development of washing systems for reusable packages. Such washing systems have been developed and manufactured for many different types of packages, such as bottles, boxes, trays and pallets.

Washing systems for packages, such as boxes, trays and pallets, are typically constructed as industrial washing systems having a very great capacity of e.g. up to 5000 boxes per hour or more, and the capacity is increased in step with the customers' demands. Such systems typically have a length of more than 30 m, and therefore appear as large, space-requiring steel structures. Each system thus represents a considerable investment for the owners. Generally, the systems are divided into zones for softening, washing and flushing, which contain tanks having a capacity of 500-10,000 litres, pumps and filters for detergent and water as well as nozzles for the flushing of the package. Also, the systems frequently comprise a drying zone with air blowers.

The washing systems are preferably made of stainless steel plates, the reason being the need for resistance to corrosion, because detergents having a great decomposing and washing ability, which may have a corrosive effect, are used, but also because the system must be capable of being cleaned effectively.

The requirement of effective cleaning of the washing system is met inter alia in that all joints of steel plates are full-welded, ground and polished, and that solutions without corners, cracks or difficult-to-reach spaces in which impurities and bacteria can thrive, are sought everywhere in the construction of the system. Thus, it is a costly process to produce such a system, because many man-hours are consumed, and because the prices of stainless steel are high. It is also an extremely expensive operation to mount these systems, because the washing tunnel has to be equipped with conveyors, guide rails, washing nozzles, drains, tanks, filters and pumps, which is a great piece of work with a great consumption of hours.

The system also has considerable costs in operation. For one thing, detergents, water and power are to be used, and, for another, the water has to be heated. Therefore, the systems are constructed with a view to reducing these operating costs. The water supply is equipped with fitters and pumps so that the water may be recirculated and reused so as to save water. To reduce the heat loss from the heated water, the systems are frequently constructed with double walls and doors in all the sections in which hot water occur. The systems may also be configured with walls and doors constructed as a sandwich structure, where the insulation is arranged between stainless steel plates, which are also full-welded to create tightness for the insulation material.

U.S. Pat. No. 2,633,437 discloses a washing machine for kitchen utensils, which is constructed as stated above, and which does not make allowance for energy savings or working environment. The machine comprises a tunnel for chemical washing, flushing with clean water, flushing with cleaned water and drying. The tunnel is equipped with water nozzles, an air nozzle, tanks, a pump and a conveyor. The conveyor divides the tunnel into a washing tunnel and a tank unit, but the construction does not allow extension of the tunnel for greater capacity.

U.S. Pat. No. 5,419,349 discloses a portable small parts washer. The washer includes a tunnel (washer tank), which is cylindrical and made of synthetic material. The internal space of the tunnel comprises a section with nozzles for spraying pressurized water at the parts, which are placed on a conveyor extending throughout the tunnel. The internal space below the conveyor is functioning as a drain leading the water to a water reservoir placed outside the tunnel. The document discloses no solutions regarding extending the washer.

It has been attempted to construct transport systems with pipes of glass fibre reinforced polyester. The pipes were used for moving the package from one station to another by allowing water to flow through the pipes and thereby push the package forwards. The pipes were to be supported by a frame, and, at cut-outs in the pipes, the sides were supported by bands or rings which had been passed around the sides of the pipes in order to avoid collapse of the pipes. To avoid heat losses, the pipes were provided with an external insulation.

It is described in the applicant's Danish Patent Application PA 2006 01574 how a washing tunnel for a washing system may be constructed from a pipe of synthetic material, which has been cut into an upper part and a lower part. It is argued in the application that precisely this structure of a washing tunnel gives great savings in the manufacture and the mounting with the concurrent achievement of a great reduction of heat waste and noise. However, double pipe combinations are used in several situations in order to have sufficient tank capacity for the washing water and special structures of filter modules, which must also establish a connection to a subsequent section.

### THE OBJECT OF THE INVENTION

It is the object of the invention to remedy these many drawbacks, and this is achieved by constructing the washing system such that the internal space of the tunnel comprises both a washing tunnel and a water reservoir, separated from each other by at least one package conveyor, and that the tunnel further is adapted to be extended with one or more pipes disposed in extension of each other.

The invention surprisingly and advantageously provides for simplification of the entire system, as one and the same pipe comprises washing tunnel, conveyor and water reservoir, and the system may therefore be extended by coupling several pipes in extension of each other so as to form a tunnel adapted to contain the functions softening, washing, flushing and drying.

When the interior of the pipe is divided into a washing tunnel disposed in the upper part of the pipe and a water reservoir disposed in the lower part, a good utilization of the interior space of the pipe is achieved as well as an advantageous and sufficient water capacity, while the possibilities of coupling to subsequent pipes or filter or pump units are simplified to a considerable extent.

The use of a pipe made of synthetic material provides for access to a material and a product which, as a standard, can be delivered in lengths, diameters, thicknesses and with properties as desired. Moreover, it is attractive for the making of a washing tunnel, because the material is easy to configure by cutting, gluing and welding, it is hygienic because of the shape of the pipe and the round faces which do not contain edges or shape-bent parts, and in the proper thicknesses it is self-supporting and sound and heat insulating, so that further support and insulation may be reduced or avoided. These properties therefore contribute to a significant reduction in the initial and operating costs.

When, as stated in claim 2, the washing tunnel and the water reservoir are additionally separated from each other by a drain bottom, it is ensured in a simple manner that dirty water from the washing tunnel may be kept separated from clean water in the reservoir.

When, as stated in claim 3, the drain bottom is configured as a vessel with sides and a bottom and with a drain to a filter, and the sides and the bottom of the drain bottom are adapted to the shape and the dimensions of the pipe, it is ensured that the pipe may be divided by introducing the drain bottom from an open pipe end and securing it to the sides of the pipe. The drain communicates with a filter via an opening in the side of the pipe.

When, as stated in claim 4, the drain bottom is provided with support brackets and fittings for one or more package conveyors and equipment for one or more of the functions softening, washing and flushing, and the equipment is mounted subsequently, it is ensured that the pipes of the washing tunnel may be divided, and the selected functions are established at once by introducing the fully mounted drain bottom from an open pipe end by means of e.g. a fork-lift truck. This results in a considerable saving of mounting hours.

As stated in claim 5, it is expedient to construct and place the drain bottom in the pipe adapted to the number of conveyors, the size of the package and the diameter of the pipe.

When, as stated in claim 6, the washing tunnel is equipped with support brackets and fittings for one or more package conveyors and for equipment for one or more of the functions softening, washing, flushing and drying, it is ensured that the pipe may be adapted to a desired function, package size and washing capacity.

As stated in claims 7 and 8, it is expedient to introduce one or more inspection doors on the tunnel and to support it.

As stated in claim 9, it is advantageous to cut the tunnel and thereby the pipe into an upper part and a lower part, so that the tunnel may be opened for mounting, inspection or cleaning.

As stated in claim 10, it is advantageous to arrange the tunnel with an inlet which, depending on the function of the tunnel, leads to the washing tunnel or to the water tank, and with an outlet which is optionally positioned at the same end of the tunnel as the inlet or at the opposite end.

When, as stated in claims 11 and 12, the water tank is equipped with a water-based transport system and guide rails for the package, it is ensured that the packages may be immersed so that softening may take place at the same time as the packages are moved.

When, as stated in claims 13 to 15, the packages are fed as stated by combining immersion and softening with subsequent flushing and washing above the water, and the packages are subjected to several forward and backward passes, a very effective and economical cleaning of the package is ensured, with a great capacity in systems which take up relatively lithe space.

### THE DRAWING

Preferred exemplary embodiments will be described more fully below with reference to the drawing, which shows the principles of the invention in out-line, and in which

FIG. 1 shows a washing system according to the invention seen in perspective,

FIG. 2 shows a drain bottom seen in perspective,

FIG. 3 shows a pipe seen from the end, with drain bottom, support brackets, conveyor and nozzles,

FIG. 4 shows a drain bottom fully mounted with all the equipment for a section,

FIGS. 5a and 5b show a pipe seen from the end with a drain bottom in a low and high position respectively,

FIG. 6 shows a washing system with an open washing tunnel,

FIG. 7 shows a basic sketch of a washing system, in which the tank is equipped with a transport system for the feeding of packages in an immersed state, and

FIGS. 8a, 8b, 8c, 8d show sketches with feeding patterns in a washing tunnel.

### DESCRIPTION OF THE EXEMPLARY EMBODIMENTS

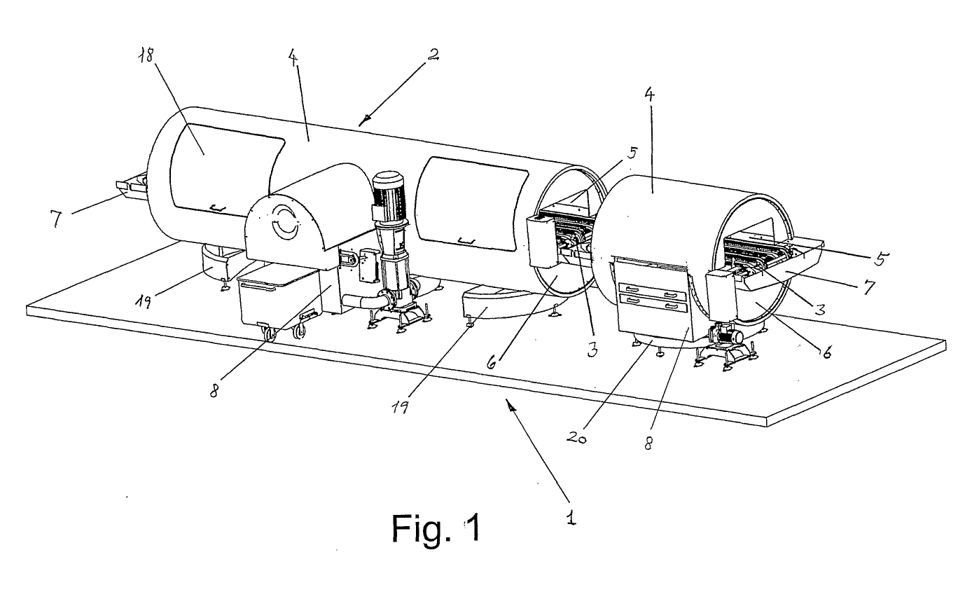

FIG. 1 shows a washing system 1 according to the invention for the washing of returnable and reusable packages. The washing system 1 comprises a horizontally disposed tunnel 2 which is made of a pipe 4 of extruded or wound synthetic material, said pipe being divided into a washing tunnel 5 disposed in the upper part of the pipe and into a water reservoir 6 disposed in the lower part of the pipe, separated from each other by a conveyor 3 and a drain bottom 7, as well as one or more filter and pump units 8 arranged on the outer side of the pipe. In washing systems for great capacity and/or large packages, several such systems may be coupled in extension of each other or be arranged in parallel.

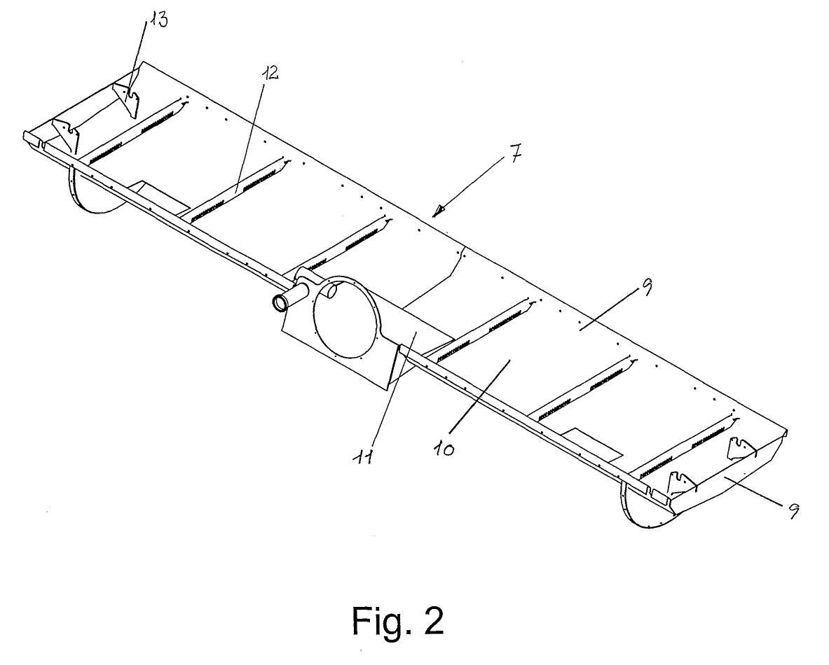

FIG. 2 shows the structure of a drain bottom 7. The drain bottom is configured with sides 9 and a bottom 10 with a drain 11 to a filter. The bottom is configured such that the water will seek toward the centre of the bottom and toward the drain 11. The longitudinal sides are configured so as to follow the internal shape of the pipe 4 and are capable of tightly engaging the sides of the pipe. This makes it easy to establish a seal between the upper washing tunnel 5 and the subjacent water reservoir 6. Attachment of the drain bottom is carried out with screws or bolts through the sides of the pipe. The drain 11 is passed out through the side of the pipe 4 to the filter and pump unit 8, from which there is a connection to the tank 6.

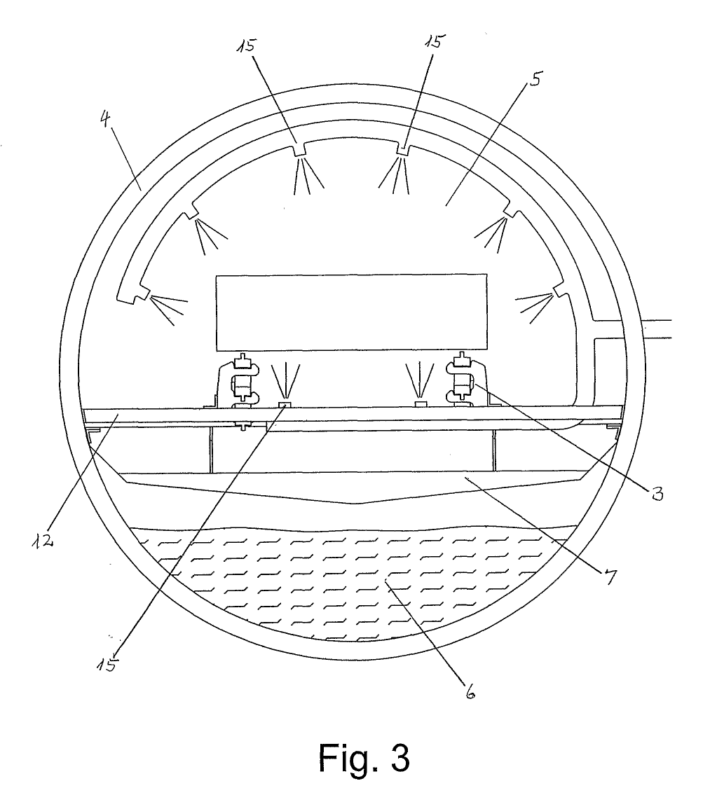

FIG. 1 and FIG. 3 show how the washing tunnel 5 may be arranged. The washing tunnel is arranged for one or more of the functions softening, washing, flushing and drying. The division is determined inter alia by capacity and package sizes. In case of small packages, e.g. the functions softening, washing and flushing may be performed in a single pipe of 6 m. On the other hand, it will be expedient to connect a further pipe for the flushing function, if the packages are large or they are very dirty, so that they have to stay for an extended period of time in a softening or washing zone in order to become dean.

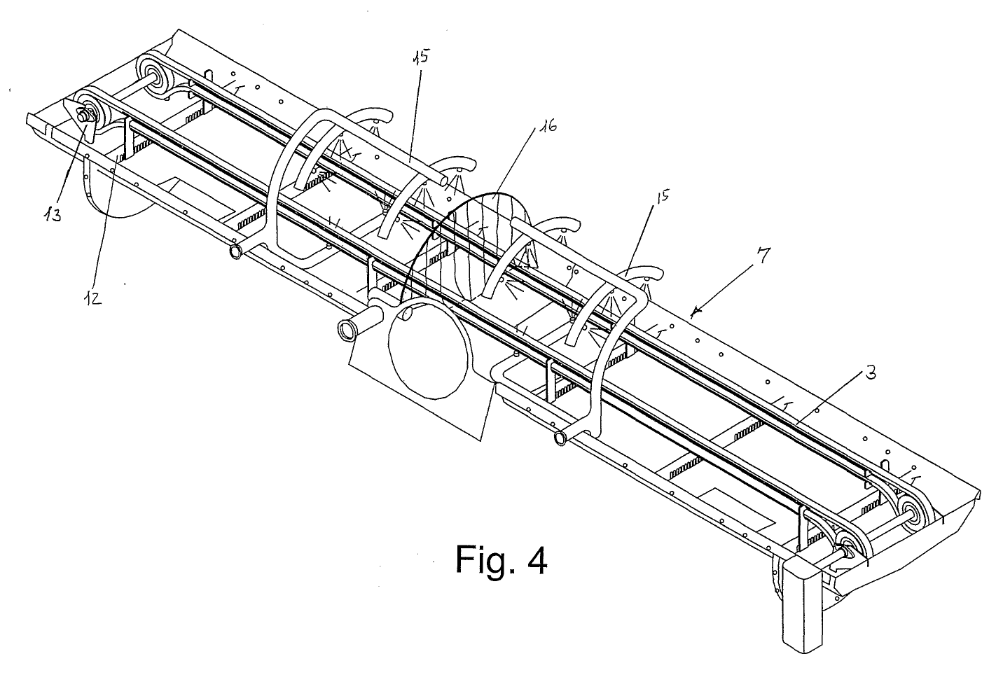

The washing tunnel 5 always comprises at least one package conveyor 3 which is to carry the package through the entire system. The conveyor is provided with carriers and with adjustable guides, so that the package is held firmly during the process, also even though the package is subjected to strong flushing jets from all angles. The conveyor is arranged on support brackets 12 which are secured to the sides of the pipe. The same support bracket may also be used as an attachment for the nozzles 15. Other fittings 13 (see FIG. 4) may likewise be used to advantage. Brackets and fittings are always adapted to the purpose and position in the pipe. The washing tunnel is frequently equipped with partition curtains 16 between the individual function zones, so that the water from the nozzles in one zone is not mixed with the water in a subsequent zone.

FIG. 4 shows the structure of a drain bottom 7, where all the equipment is mounted on the drain bottom so that a washing tunnel may be established at once by introducing the fully mounted drain bottom via an open pipe end. This results in a great saving in the manufacture and mounting. The drain bottom 7 is equipped with a plurality of brackets 12 and fittings 13 which are secured to the drain bottom, enabling mounting and attachment of a pack-age conveyor 3. Nozzles 15, which may be mounted on water supply pipes or on brackets and fittings, are arranged above and below the conveyor. The figure moreover shows a partition curtain 16.

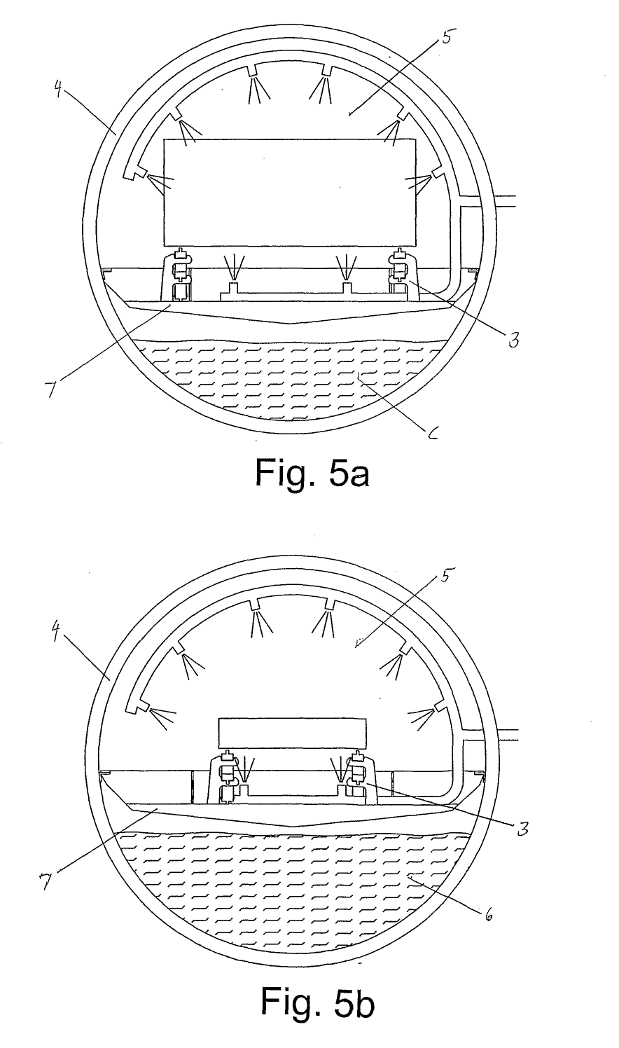

FIG. 5a shows a washing tunnel 5 with the drain bottom 7 arranged in a low position in the pipe 4 so as to make room for a large or a tall package in the washing tunnel. FIG. 5b shows a drain bottom 7 arranged in a high position in the pipe 4, which is expedient with low or wide packages, it being desired to utilize the largest inside diameter of the pipe. The diameter of the pipe and the position of the drain bottom and the number of conveyors are selected on the basis of the package type and the customer's wish for system capacity.

The washing process usually comprises the functions softening, washing, flushing and drying in the mentioned order.

The dirty packages are introduced into the softening zone in which they are subjected to flushing with hot water with detergent at a water pressure of 2 to 4 bars. Dirt and labels are hereby dissolved in the water, which is re-turned via drain and filter to the water reservoir 6, in which the filtered water is again conveyed forwards via a pump to the nozzles 15 for reuse. Detergent is fed automatically.

Then, the package is passed further on to the washing zone in which it is flushed with hot water and detergent at a pressure of 6 to 12 bars, so that all impurities are removed. The used water and detergent are returned via a drain and a filter to the water reservoir 6 for washing water, before it is pumped forwards again for reuse. Detergent is fed automatically.

After washing, the package is passed further on for flushing with clean water, which may be cold or hot. The flushing takes place at a water pressure of about 2 bars. The used flushing water may be used for replenishing the washing water in the washing zone, just as the washing water may be re-used in the softening zone. In special cases where the hygiene requirements are high, disinfectants are added to the flushing water.

To facilitate the cleaning of the packages, nanoparticles may be added to the flushing water so that the packages obtain a smooth and dirt-repelling surface,

After flushing, the package is conveyed to drying in a drying zone in which a plurality of blowers with knife-shaped nozzles send a strong flow of air from above and from below as an air blanket past the package, whereby the water is blown off in a few seconds. The capacity of the blowers is typically 5-7.5 kW, and the amount of air is typically of the order of 2200 m³.

In an embodiment, the pipe 4 is made of extruded or wound synthetic material of the type polyethylene (PE), and the material is used to a great extent for pipes for pipelines under pressure. The pipes are made in many sizes, and pipes in lengths of up 6 metres, with an outside diameter from 700 to 2000 mm and with thicknesses from 18 mm to 55 mm are suitable for washing tunnels. Other materials may also be used, provided that their properties are comparable to polyethylene. The pipe or the pipes have a circular or essentially circular cross-section.

The material is suitable for the transport of water and liquids and is used to a great extent in water works and the chemical industries. The pipe is hygienic in use because of the smooth faces inside and outside and is more-over very stable and self-supporting because of the shape and the great thickness, and cuffing of the pipe involves no sagging of the pipe wall caused by released stresses. It has moreover been found that the material has good sound and heat insulating properties, which is advantageous in connection with washing tunnels. The material maintains its mechanical properties at temperatures which are considerably above the water temperatures in the washing tunnel.

In an embodiment, the pipe 4 may be made of glass fibre reinforced plastics—a material which may be used to advantage in washing systems which are to operate at relatively high temperatures.

As shown in FIG. 1, the pipe 4 is equipped with doors 18 for mounting, inspection and cleaning. In those cases where a package is defective, it may happen that the defective package causes blocking. The package may then be removed via one of the doors 18.

The washing system is supported at one or more places. The support comprises cut lengths 19, 20 of the pipe 4. The pipe length 19 is cut into two halves which are arranged below the ends of the washing system. The pipe length 20 is arranged below the washing system at the place where the filter and pump unit is disposed. Hereby, the system is lifted slightly above the floor so that cleaning below the system is facilitated.

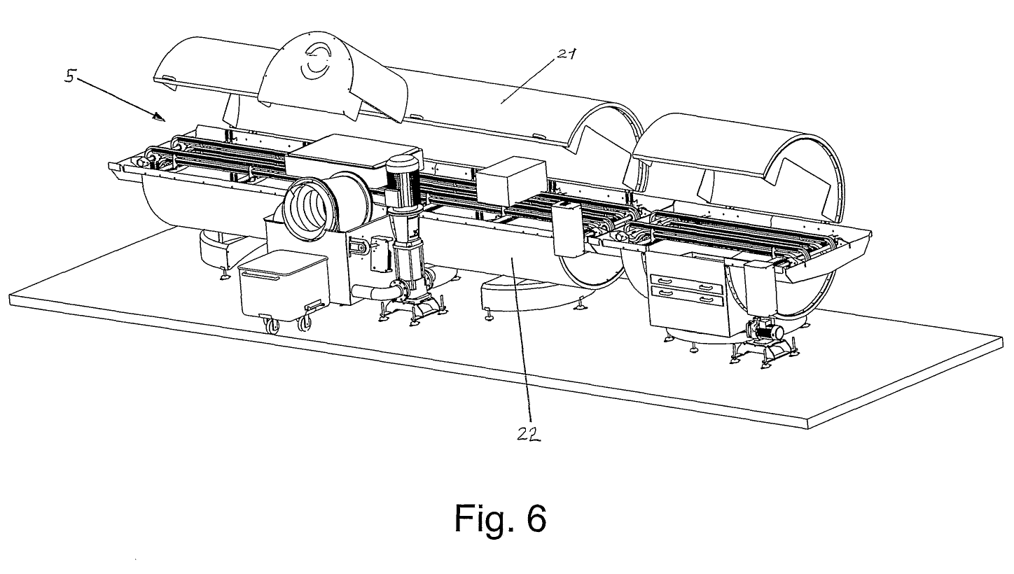

FIG. 6 shows an embodiment of the washing system, where the washing tunnel may be opened. In the first embodiment shown, the washing tunnel is equipped with hinges along the side via which the upper part may be pivoted up, but, in a second embodiment, may be opened in that the upper part is pivoted up via hinges arranged on the pipe end, or, in a third embodiment, in that the entire upper part is lifted by means of a hoist arrangement.

As stated, a complete washing system may be established by the coupling together of pipes arranged with equipment for softening, washing, flushing and drying. It will be evident to a skilled person that such a system may be coupled together with external conveyors on the inlet side as well as the outlet side of the system and thereby be included in automatic lines. It is likewise clear that several such systems may be setup in parallel, so that the capacity may be multiplied, or that a washing tunnel may be equipped with several lanes.

In special cases, the washing system 1 may be extended with a length of pipe having smaller pipe diameter than the other pipes of the washing system, which length of pipe is not divided by a conveyor or a drain bottom, but just contains a washing tunnel with a conveyor and a plurality of nozzles. Such a length of pipe may be used in those cases where a great water capacity is not needed, and where the washing function may be coupled to a water reservoir disposed in one of the subsequent pipes of the washing system.

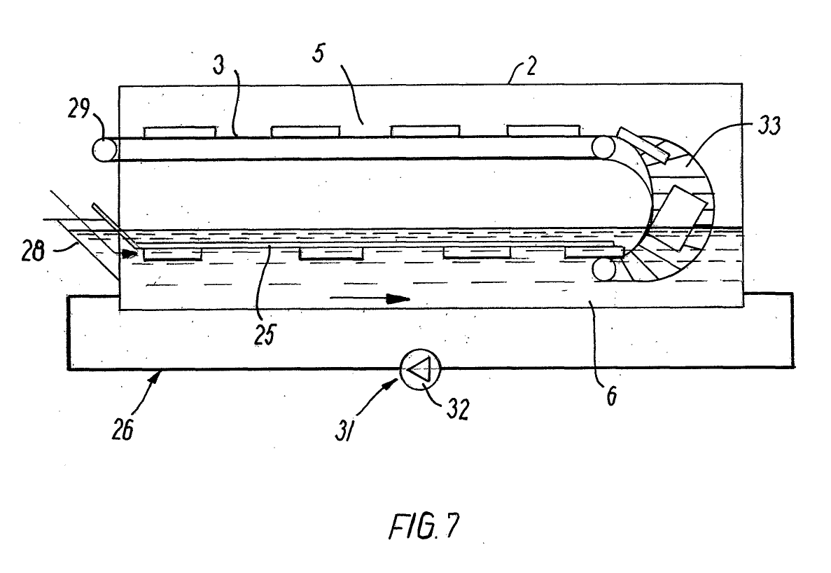

In those cases where the package is particularly dirty and therefore needs intensive softening before washing and flushing, the water reservoir 6 of the washing system may be equipped with a conveyor system 26 for the feeding of the packages in an immersed state. For the packages to be introduced into the water reservoir, an entry opening 28 is arranged at the end bottom of the water reservoir, see FIG. 7.

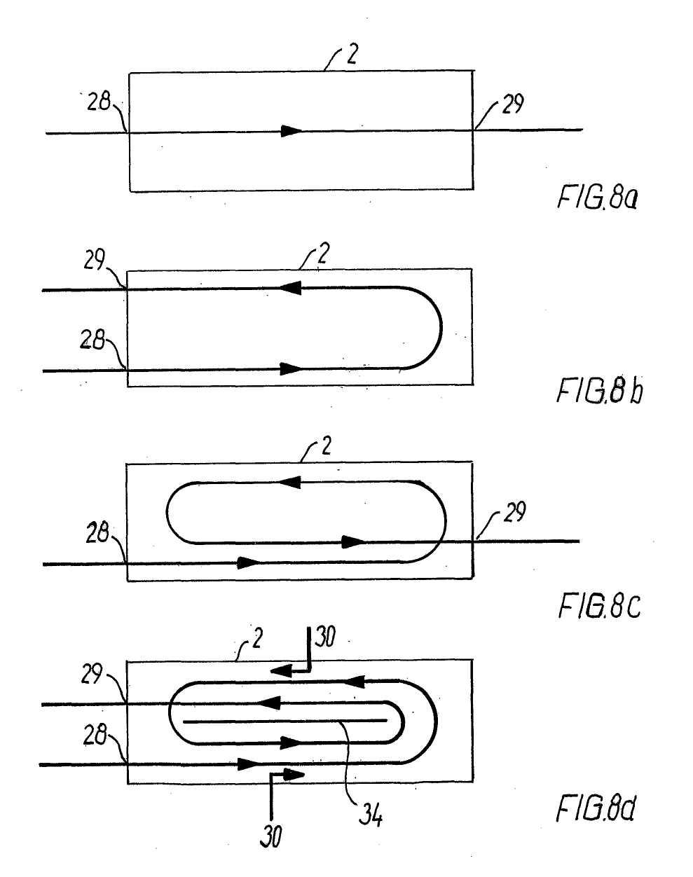

The conveyor system 26 comprises guide rails 25 which extend from the entry opening and further through the water reservoir to an outlet 29 or to a flexible curve conveyor 33. The guide rails keep the package immersed and on the track through the water reservoir. Also included is a flow generator 31 which, in one embodiment, is formed by a pump 32 inserted into an external pipe system which extends between the end bottoms of the water reservoir, and which, in another embodiment, is formed by one or more water jet nozzles 30 (see FIG. 8d), which will typically be supplied from the water reservoir via an external pump.

After the packages have been moved through the water reservoir, they are passed further on to an outlet opening 29, and from there further on to a subsequent washing section, see FIG. 8a, but they may also be lifted out of the water by a flexible curve conveyor 33 which places them on a package conveyor 3, which then moves them back to an outlet opening 29 disposed at the same end as the entry opening 28, see FIGS. 7 and 8b.

If further washing should be required, the package may be passed through the washing tunnel once more, see FIG. 8c. In that case the washing tunnel is equipped with an additional flexible curve conveyor and an additional package conveyor so that the package is moved forwards to an outlet opening 29 disposed at the opposite end of the entry opening.

Both softening and washing may be intensified by first moving the package forwards and backwards in an immersed state with the transport system 26, and then forwards and backwards on the package conveyors 3, see FIG. 8d. In that case, the transport system is provided with one or more water jet nozzles, and the water circulation is achieved inter alia by arranging a partition wall 34 at the bottom of the tank.

1. A washing system (1) for returnable and reusable packages for foods and beverages or other products, in particular for the washing of boxes, trays, pallets and the like of plastics or steel, said washing system comprising a tunnel (2) which is provided with equipment for one or more of the functions softening, washing, flushing and drying, which equipment comprises nozzles, partition curtains, air blowers, tanks, filters, pumps and a package conveyor, and which is also adapted to cooperate with supply as well as discharge arrangements, and in which the tunnel (2) comprises a pipe (4) of synthetic material which is generally cylindrical and disposed substantially horizontally, characterized in that the internal space of said tunnel (2) comprises both a washing tunnel (5) and a water reservoir (6) separated from each other by at least one package conveyor (3), and that the tunnel (2) further is adapted to be extended with one or more pipes (4) disposed in extension of each other.

2. A washing system according to claim 1, characterized in that the washing tunnel (5) and the water reservoir (6) are additionally separated from each other by a drain bottom (7).

3. A washing system according to claim 1, characterized in that the drain bottom (7) is configured as a vessel with sides (9) and a bottom (10) and a drain (11) to a filter and pump unit (8), and that sides and bottom are adapted to the shape and the dimensions of the pipe (4).

4. A washing system according to claim 2, characterized in that the drain bottom (7) is configured as a vessel with a drain and a filter and pump unit (8) and with sides and a bottom which are adapted to the shape and the dimensions of the pipe, and that the drain bottom additionally comprises a plurality of support brackets (12) and fittings (13) adapted for the mounting of one or more package conveyors (3) as well as other equipment (15, 16) for one or more of the functions selected from the group consisting of softening, washing and flushing, and that the pipe (4) is adapted to receive the drain bottom with mounted equipment (3, 15, 16).

5. A washing system according to claim 2, characterized in that the dimensions of the drain bottom and its position in the pipe are adapted to the number of package conveyors as well as the size of the package and the diameter of the pipe.

6. A washing system according to claim 1, characterized in that the washing tunnel (5) is equipped with support brackets (12) and fittings (13) for one or more package conveyors (3) and other equipment (15, 16, 17) for one or more of the functions selected from the group consisting of softening, washing, flushing and drying.

7. A washing system according to claim 1, characterized in that the tunnel (2) is equipped with one or more inspection doors (18).

8. A washing system according to claim 1, characterized in that the tunnel (2) is supported by cut lengths (19, 20) of the pipe (4).

9. A washing system according to claim 1, characterized in that the tunnel (2) and thereby the pipe (4) are cut in the horizontal plane into an upper part and a lower part (21, 22), so that the tunnel may be opened for mounting, inspection or cleaning.

10. A washing system according to claim 1, characterized in that the tunnel (2) is equipped with an entry opening (28) for packages, said entry opening leading to the washing tunnel (5) or to the water reservoir (6), as well as an outlet opening (29).

11. A washing system according to claim 1, characterized in that the water reservoir (6) comprises a transport system (26) for the feeding of packages in an immersed state, said transport system comprising guide rails (25) for the package and a flow generator (31).

12. A washing system according to claim 11, characterized in that the flow generator (31) comprises a pump (32) or one or more water jet nozzles (30).

13. A method of feeding returnable and reusable packages in a washing system (1) comprising:
providing a washing system (1) for returnable and reusable packages for foods and beverages or other products, in particular for the washing of boxes, trays, pallets and the like of plastics or steel, said washing system having a tunnel (2) which is provided with equipment for one or more of the functions selected from the group consisting of softening, washing, flushing and drying, which equipment has nozzles, partition curtains, air blowers, tanks, filters, pumps and a package conveyor, and which is also adapted to cooperate with supply as well as discharge arrangements, and in which the tunnel (2) comprises a pipe (4) of synthetic material which is generally cylindrical and disposed substantially horizontally, an internal space of said tunnel (2) providing both a washing tunnel (5) and a water reservoir (6) separated from each other by at least one package conveyor (3), and the tunnel (2) further being adapted to be extended with one or more pipes (4) disposed in extension of each other; and
passing the package from a supply arrangement via the entry opening (28) into the washing tunnel (5) to a package conveyor (3), and thereafter moving the package in a straight line through the washing system (1) by the package conveyor to the outlet opening (29) and further on to a discharge arrangement.

14. A method of feeding returnable and reusable packages in a washing system (1) according to claim 13, characterized in that the package is passed from a supply arrangement via an entry opening (28) into the water reservoir (6) to a transport system (26), following which the package is moved forwards in an immersed state through the water reservoir (6) to the opposite end, where a flexible curve conveyor (33) and a package conveyor (3) arranged in the tunnel (2) pass the package back to an outlet opening (29) and further on to a discharge arrangement.

15. A method of feeding returnable and reusable packages in a washing system according to claim 13, characterized in that the package is passed from a supply arrangement via an entry opening (28) into the water reservoir (6) to a transport system (26), following which the package is passed forwards in an immersed state through the water reservoir to the opposite end, where a flexible curve conveyor (33) and a package conveyor 3) arranged in the tunnel (2) move the package back and further through one or more forward and backward passes to an outlet opening (29) and further on to a discharge arrangement.
